(19) United States
(12) Patent Application Publication
(10) Pub. No.: US 2021/0352938 A1
(43) Pub. Date: Nov. 18, 2021

(54) NOVEL DRINK

(71) Applicants: Raymond L. Sullivan, JR., Lawrenceville, GA (US); Chanel Carruthers, Lawrenceville, GA (US)

(72) Inventors: Raymond L. Sullivan, JR., Lawrenceville, GA (US); Chanel Carruthers, Lawrenceville, GA (US)

(21) Appl. No.: 17/319,085

(22) Filed: May 12, 2021

Related U.S. Application Data
(60) Provisional application No. 63/023,863, filed on May 12, 2020.

(51) Int. Cl. A23L 2/04; A23L 33/105; A23L 2/60; A23L 33/16

(52) U.S. Cl. CPC A23L 2/04; A23L 33/16; A23L 2/60; A23L 33/105

(57) ABSTRACT

Novel drink that is a juice and sports drink combination. In some implementations, the novel drink comprises a fruit squash, sea moss, agave nectar, key lime/lime juice, sea salt, and spring water.

### CROSS REFERENCE TO RELATED APPLICATION

This application claims the benefit of U.S. Patent Application Ser. No. 63/023,863, which was filed on May 12, 2020, and is incorporated herein by reference in its entirety.

### TECHNICAL FIELD

This disclosure relates to implementations of a novel drink.

### BACKGROUND

There does not exist a drink that has the benefits of a fruit juice and a sports drink.

### DETAILED DESCRIPTION

The present disclosure relates to a novel drink that comprises sea moss. Sea moss means Irish Sea Moss, Chondrus Crispus, Irish Moss, carrageenan, gracilaria, Agar Agar (i.e., red algae and seaweed), Dulse, or kelp.

In some implementations, the novel drink comprises sea moss, fresh fruit juice, sea salt, spring water, and agave.

In some implementations, the agave may be any form of agave.

In some implementation, the novel drink comprises sea moss, cold-pressed fruit juice, sea salt, spring water, and agave.

In some implementation, the novel drink comprises, the novel drink comprises fruit squash, Agave Nectar, Sea Salt, Agave Syrup, Spring Water, and Sea Moss.

In some implementations, the novel drink comprises agave syrup, sea moss, sea salt, fruit squash, spring water, and key lime juice.

In some implementations, the novel drink comprises fruit squash, sea moss, agave nectar, key lime/lime juice, sea salt, and spring water.

In some implementations, the novel drink does not contain vitamins.

In some implementation, the spring water may be substituted with alkaline, carbonated, coconut, distilled, flavored, filtered. glacier, infused, mineral, purified, reverse osmosis, seltzer. sparkling, spring, tap, or well water.

In some implementations, sea moss is used to replenish minerals.

In some implementations, the sea salt, spring water, and lime juice adds electrolytes to the novel drink.

In some implementations, the novel drink is a juice and sports drink combination. In other words, it is more than a juice and more than a sports drink. The combination yields unexpected results. There does not exist a drink that has the benefits or a juice and a sports drink.

In some implementations, the novel drink of the present disclosure can help with inflammation.

In some implementations, the novel drink of the present disclosure can help with libido (i.e., it is a sex enhancer)

In some implementations, the novel drink of the present disclosure can boost immunity.

In some implementations, the novel drink of the present disclosure increases energy in a drinker.

In some implementations, the novel drink comprises fruit squash; agave nectar; sea salt; agave syrup; spring water and sea moss.

In some implementations, the novel drink also includes burdock root and/or bladderwrack.

In some implementations, the novel drink comprises 16 oz of fruit squash, 5 oz of sea moss, 5 oz of agave nectar, 2 oz of key lime/lime juice, ⅝ tsp of sea salt, and 52-60 oz spring water. In some implementations, the ingredients are scalable so long as the proportions are maintained.

In some implementations, the novel drink comprise about 16 oz of fruit squash, 5 oz of sea moss, 5 oz of agave nectar, 2 oz of key lime/lime juice, ⅝ tsp of sea salt, and 52-60 oz spring water. In some implementations, the ingredients are scalable so long as the proportions are maintained.

In some implementations, the novel drink is a fruit and sea moss based health drink comprising sea moss sauce with a concentration ranging between 8.3 to 9.6% of the water in the novel drink, and extract from fruit between 26.7 to 30.7% of the water in the novel drink.

In some implementations, the novel drink is a fruit and sea moss based health drink comprising sea moss sauce with a concentration of up to 10% of the water used in the total novel drink and extract from fruit up to 35% of the water used in the total novel drink.

In some implementations, the concentration of sea moss sauce is greater than 10% of the water used in the total novel drink.

In some implementations, the fruit squash comprises organic fruit (juiced), agave powder, and spring water. In some implementations, the fruit squash comprises organic fruit (juiced), 2 tbsp of agave powder, and 1 cup of spring water. In some implementation, fruit is added to a food processor with agave powder, and spring water. The mixture is then strained to produce the fruit squash. In some implementation, a food grade cloth (e.g., cheese cloth) is used to strain the mixture.

In some implementations, the fruit squash comprises fruit juice produced using organic fruit and a cold press. In some implementation, the fruit juice from the cold press is strained as discussed above.

In some implementations, the fruit squash is useful for the preparation of refreshing, tasty, and/or healthy drink.

In some implementation, non-organic fruit may be used to make the fruit squash described above,

In some implementations, the sea moss is a sea moss sauce. The sea moss sauce is produced by taking 6 ounces of dried sea moss and soaking it in spring water and key lime juice (or lime juice). In some implementations, the dried sea moss is soaked using two freshly squeezed key limes (and or lime juice). In some implementations the dried sea moss is soaked for about 24 hours to expand the sea moss. In some implementations the dried sea moss is soaked for about 8 to 12 hours to expand the sea moss. The expanded sea moss is removed from the spring water and lime juice and then blended with spring water to make the sea moss sauce to be used in the novel drink. In some implementations, the sea moss is blended with 1 cup of spring water. In some implementations, the sea moss sauce has the consistency of syrup. In some implementations, the sea moss sauce has the consistency of cake batter. In some implementations, the sea moss sauce has a creamy consistency.

In some implementations, the sea moss sauce is useful for the preparation of refreshing, tasty, and/or healthy drink.

In some implementations, the sea salt may be replaced with any consumable salt.

In some implementations, the agave may be replaced with any consumable sugar.

In some implementations any of the following ingredients may be used in the novel drink:

Activated charcoal

ACV (apple cider vinegar)

Agave (all forms)

All Fruits

Aloe

Ashwagandha

Baobab

Beet

Bentonite Clay

Black Pepper

Blackseed Oil

Blue-green Algae

Blue Spirulina

Butterfly Pea Flower

Cacao/Raw Cacao

Camu Camu

Cayenne

Celery

Chamomile Blossoms

Chocolate

Cilantro

Citric Acid

Coconut (all forms)

Coconut Nectar (all forms of item, i.e. sweeteners)

Cucumber

Dandelion

Dates (all forms)

Elderberry

Flax seed

Ginger

Ginger

Golden Berry

Grapefruit

Grapeseed (all forms)

Hemp (all forms)/Hemp hearts

Hibiscus

High Fructose Corn Syrup

Himalayan Salt (all salts)

Italian Parsley

Maca Root

Malic Acid

Matcha

Nuts (all forms)

Peppers (all)

Potassium Chloride

Red/Regular Ginseng (all forms)

Sodium Citrate

Taurine

Turmeric

Vanilla

Vegetables (all forms)

White Granulated Sugar

To use the novel drink it is ingested orally by a human.

The novel drink can be used to prevent or treat COVID-19 or used for other ailments as discussed above (i.e., inflammation, labito, and immunity).

Details shown in the figures, such as dimensions, descriptions, etc., are exemplary, and there may be implementations of other suitable details according to the present disclosure.

Reference throughout this specification to “an embodiment” or “implementation” or words of similar import means that a particular described feature, structure, or characteristic is comprised in at least one embodiment of the present invention. Thus, the phrase “in some implementations” or a phrase of similar import in various places throughout this specification does not necessarily refer to the same embodiment.

Many modifications and other embodiments of the inventions set forth herein will come to mind to one skilled in the art to which these inventions pertain having the benefit of the teachings presented in the foregoing descriptions and the associated drawings.

The described features, structures, or characteristics may be combined in any suitable manner in one or more embodiments. In the above description, numerous specific details are provided for a thorough understanding of embodiments of the invention. One skilled in the relevant art will recognize, however, that embodiments of the invention can be practiced without one or more of the specific details, or with other methods, components, materials, etc. In other instances, well-known structures, materials, or operations may not be shown or described in detail.

While operations may be depicted in the drawings in a particular order, this should not be understood as requiring that such operations be performed in the particular order shown or in sequential order, or that all illustrated operations be performed, to achieve desirable results.

1. A drink comprising sea moss sauce with a concentration ranging between about 8.3 to 9.6% of the water in the drink, fruit extract with a concentration ranging between about 26.7 to 30.7% of the water in the drink, and water.

2. The drink of claim 1 where in the water is spring water.

3. The drink of claim 1 further comprising sea salt.

4. A fluid comprising sea moss, cold-pressed fruit juice, sea salt, spring water, and agave.

5. A method wherein human subjects are given to drink the fluid of claim 4.

6. A fluid comprising sea moss, fruit juice, sea salt, spring water, and agave.

7. A method wherein human subjects are given to drink the fluid of claim 6.
